(19) United States
(12) Patent Application Publication
(10) Pub. No.: US 2025/0189619 A1
(43) Pub. Date: Jun. 12, 2025

(54) ELECTRONIC DEVICE AND LOCATION MEASUREMENT METHOD USING SAME

(71) Applicant: Samsung Electronics Co., Ltd., Suwon-si (KR)

(72) Inventors: Sangyoun LEE, Suwon-si (KR); Sinwoo PARK, Suwon-si (KR); Kyuhui HAN, Suwon-si (KR); Choonghoon KIM, Suwon-si (KR); Youngil NAM, Suwon-si (KR); Sejin KWEON, Suwon-si (KR); Seungjae LEE, Suwon-si (KR)

(21) Appl. No.: 19/057,398

(22) Filed: Feb. 19, 2025

Related U.S. Application Data
(63) Continuation of application No. PCT/KR2023/012092, filed on Aug. 16, 2023.

(30) Foreign Application Priority Data
Sep. 1, 2022 (KR) 10-2022-0110613
Oct. 17, 2022 (KR) 10-2022-0133198

(51) Int. Cl. G01S 5/14; G01S 5/02; H04W 64/00

(52) U.S. Cl. CPC G01S 5/14; G01S 5/0244; H04W 64/00

(57) ABSTRACT

An electronic device is provided. The electronic device includes a communication circuit configured to communicate with an external electronic device, memory, storing one or more computer programs, including map information including location information of a plurality of access points (APs) in a specific area, and one or more processors communicatively coupled to the communication circuit and the memory, wherein the one or more computer programs include computer-executable instructions that, when executed by the one or more processors individually or collectively, cause the electronic device to determine, based on the map information, at least one AP located within a certain distance from a first location of the electronic device among the plurality of APs as a first group, determine, based on a signal received from the AP in the first group, a first distance between an AP in the first group and the electronic device, determine, based on the map information, a second distance between the AP in the first group and the electronic device, determine an AP in which a difference between the first distance and the second distance is less than a certain level among at least one AP in the first group as a second group, and determine a second location of the electronic device by using an AP in the second group, wherein the first location is determined based on a signal broadcast by the plurality of APs in the specific area.

### CROSS-REFERENCE TO RELATED APPLICATION(S)

This application is a continuation application, claiming priority under 35 U.S.C. § 365(c), of an International application No. PCT/KR2023/012092, filed on Aug. 16, 2023, which is based on and claims the benefit of a Korean patent application number 10-2022-0110613, filed on Sep. 1, 2022, in the Korean Intellectual Property Office, and of a Korean patent application number 10-2022-0133198, filed on Oct. 17, 2022, in the Korean Intellectual Property Office, the disclosure of each of which is incorporated by reference herein in its entirety.

### BACKGROUND

### 1. Field

The disclosure relates to an electronic device. More particularly, the disclosure relates to a method for efficiently determining an indoor location of a mobile electronic device by using a short-range wireless network technology.

Various embodiments of the disclosure relate to reducing the calculation error of the distance to the electronic device and improving the location estimation result by selectively using some of a plurality of wireless access points (APs) or anchor devices.

### 2. Description of Related Art

With the proliferation of various electronic devices, speed improvement for wireless communication that may be used by various electronic devices has been implemented. Among the wireless communications supported by recent electronic devices, Institute of Electrical and Electronics Engineers (IEEE) 802.11 wireless local area network (WLAN) (or wireless fidelity (Wi-Fi)) is a standard for implementing high-speed wireless connections on various electronic devices. The first Wi-Fi implemented could support a transmission rate of up to 1 to 9 Mbps, but Wi-Fi 6 technology (or IEEE 802.11ax) may support a transmission rate of up to about 10 Gbps.

An electronic device may support various services (e.g., ultra high definition (UHD) quality video streaming service, augmented reality (AR) service, virtual reality (VR) service, and/or mixed reality (MR) service) using relatively large-capacity data through wireless communication supporting high transmission rate, and may also support various other services. The electronic device may support a real-time location system, which is a service that determines the location of an electronic device through short-range wireless communication.

A real-time location system (RTLS) may track the location of an object in real time by using short-range wireless communication technology inside a building. The RTLS may be used in at least one of warehouse automation, transportation and logistics, vehicle control, or traffic hubs by utilizing data including the location of the object. The core function of the RTLS is to determine the location of a mobile object in a limited space. The RTLS may determine which wireless communication technology to use by considering at least one of the reflection, diffraction, absorption of radio waves due to building walls, precision of required location results, various spatial characteristics, and technical and cost aspects. The RTLS may use at least one communication technology of Wi-Fi, Bluetooth, Bluetooth low energy (BLE), ultra wideband (UWB), Zigbee, or radio frequency identification (RFID) to determine the location of the mobile object. The RTLS may receive signals from a plurality of fixed wireless access points (hereinafter, referred to as APs) or anchor devices, and calculate the distance and location of the electronic device based on map information of the mobile area. The distance and location calculation method may vary depending on the communication technology used. The distance and location calculation method may include at least one of, for example, angle of arrival (AoA), time of arrival (ToA), time difference of arrival (TDoA), received signal strength indicator (RSSI), time of flight (ToF), or symmetric double sided two way ranging (SDS-TWR). The RTLS may be mixed with triangulation or trilateration method to calculate the location.

An electronic device may use the 802.11mc fine timing measurement (FTM) technology that is a distance estimation protocol using the round-trip time (RTT) of a Wi-Fi signal. The FTM may refer to a method of measuring the round-trip time by exchanging wireless signals between two Wi-Fi devices and multiplying the measured value by the speed of the signal to estimate the round-trip distance between the two devices.

The above information is presented as background information only to assist with an understanding of the disclosure. No determination has been made, and no assertion is made, as to whether any of the above might be applicable as prior art with regard to the disclosure.

### SUMMARY

Since Wi-Fi has a relatively narrow bandwidth (e.g., 20 to 80 MHz), it may be difficult to finely decompose signal components received via multiple paths. When the straight path between the transmitter and receiver is blocked by an obstacle or the received signal strength of the straight path is similar to that of other multipath components, a large error may occur in the detection of the arrival time of the straight path component, which may deteriorate the distance estimation performance. In addition, the FTM protocol has the disadvantage of having to exchange Wi-Fi frames at least twice to dozens of times to obtain a single distance measurement value, which may degrade overall network performance by congesting Wi-Fi channels if many mobile devices use the FTM protocol at the same time.

Methods, such as ToA, TDoA, ToF, and RTT that calculate the distance based on the arrival time of a signal may have difficulty in detecting the component that reaches the receiver first among the multipath components when signals are received overlapping at the receiver due to the multipath propagation characteristics of wireless signals. In particular, when the straight path between the transmitter and receiver is blocked by an obstacle and does not exist or the received signal strength of the straight path is similar to that of other multipath components, a large error may occur in the detection of the arrival time of the straight path component, which may deteriorate the distance estimation performance. In order to accurately estimate the location of a mobile object in RTLS, it may be important to secure the line-of-sight (LoS) of the signal between the mobile object and the AP. Depending on the movement path of the mobile object, there may be an external object between the mobile object and the AP, resulting in a non-line-of-sight (NLoS) environment where there is no straight path between the mobile object and the AP device, and a situation may also occur where the AP is obscured by objects other than the mobile object, and if it is difficult to distinguish the multipath signals due to NLoS, there is a limit that the error in the estimated distance between the mobile object and the AP increases.

Aspects of the disclosure are to address at least the above-mentioned problems and/or disadvantages and to provide at least the advantages described below. Accordingly, an aspect of the disclosure is to provide a method for efficiently determining an indoor location of a mobile electronic device by using a short-range wireless network technology.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit that communicates with an external electronic device, memory, storing one or more computer programs, including map information including location information of a plurality of access points (APs) in a specific area, and one or more processors, communicatively coupled to the communication circuit and the memory, wherein the one or more computer programs include computer-executable instructions that, when executed by the one or more processors individually or collectively, cause the electronic device determine, based on the map information, at least one AP located within a certain distance from a first location of the electronic device among the plurality of APs as a first group, determine, based on a signal received from the AP in the first group, a first distance between an AP in the first group and the electronic device, determine, based on the map information, a second distance between the AP in the first group and the electronic device, determine an AP in which a difference between the first distance and the second distance is less than a certain level among at least one AP in the first group as a second group, and determine a second location of the electronic device by using an AP in the second group, wherein the first location is determined based on a signal broadcast by the plurality of APs in the specific area.

In accordance with another aspect of the disclosure, a method of measuring a location of the electronic device is provided. The method includes determining, by the electronic device, based on map information including location information of a plurality of APs in a specific area, at least one AP located within a certain distance from a first location of the electronic device among the plurality of APs as a first group, determining, by the electronic device, based on a signal received from the AP in the first group, a first distance between an AP in the first group and the electronic device, determining, by the electronic device, based on the map information, a second distance between the AP in the first group and the electronic device, determining, by the electronic device, an AP in which a difference between the first distance and the second distance is less than a certain level among at least one AP in the first group as a second group, and determining, by the electronic device, a second location of the electronic device by using an AP in the second group, wherein the first location is determined based on a signal broadcast by the plurality of APs in the specific area.

According to an embodiment of the disclosure, in configuring RTLS, the efficiency of network resources in the mobile area may be improved.

According to an embodiment of the disclosure, it is possible to improve the location estimation result of an electronic device by reducing the distance calculation error between the electronic device that is a mobile object and multiple fixed APs.

According to an embodiment of the disclosure, it is possible to improve the location estimation result of an electronic device by estimating the location of the electronic device after collecting distance information by selecting only APs that are close to the electronic device and by additionally selecting only APs having a small distance error to correct the location of the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations of measuring a location of an electronic device are provided. The operations include determining, by the electronic device, based on map information including location information of a plurality of APs in a specific area, at least one AP located within a certain distance from a first location of the electronic device among the plurality of APs as a first group, determining, by the electronic device, based on a signal received from the AP in the first group, a first distance between an AP in the first group and the electronic device, determining, by the electronic device, based on the map information, a second distance between the AP in the first group and the electronic device, determining, by the electronic device, an AP in which the difference between the first distance and the second distance is less than a certain level among at least one AP in the first group as a second group, and determining, by the electronic device, a second location of the electronic device by using an AP in the second group, wherein the first location is determined based on a signal broadcast by the plurality of APs in the specific area.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a view illustrating an embodiment of determining an angle of arrival of a signal transmitted by an external electronic device in an electronic device according to an embodiment of the disclosure;

FIG. 3 a view illustrating a method of measuring a location of an electronic device according to an embodiment of the disclosure;

FIG. 4 is a view illustrating a situation in which an obstacle exists in a situation of measuring a location of an electronic device according to an embodiment of the disclosure;

FIG. 5 is a view illustrating an embodiment of determining a distance to an external device by using a fine timing measurement (FTM) in an electronic device according to an embodiment of the disclosure;

FIG. 6 is a view illustrating an embodiment in which an electronic device determines a location of the electronic device according to an embodiment of the disclosure;

FIG. 7A is a block diagram illustrating a configuration of an electronic device according to an embodiment of the disclosure;

FIG. 7B is a view illustrating a network configuration of a real-time location system (RTLS) in an electronic device according to an embodiment of the disclosure;

FIG. 8 is a flowchart illustrating a method of measuring a location of an electronic device according to an embodiment of the disclosure;

FIG. 9 is a flowchart illustrating a method of measuring a location of an electronic device according to an embodiment of the disclosure;

FIG. 10 is a flowchart illustrating a method of measuring a location of an electronic device according to an embodiment of the disclosure;

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

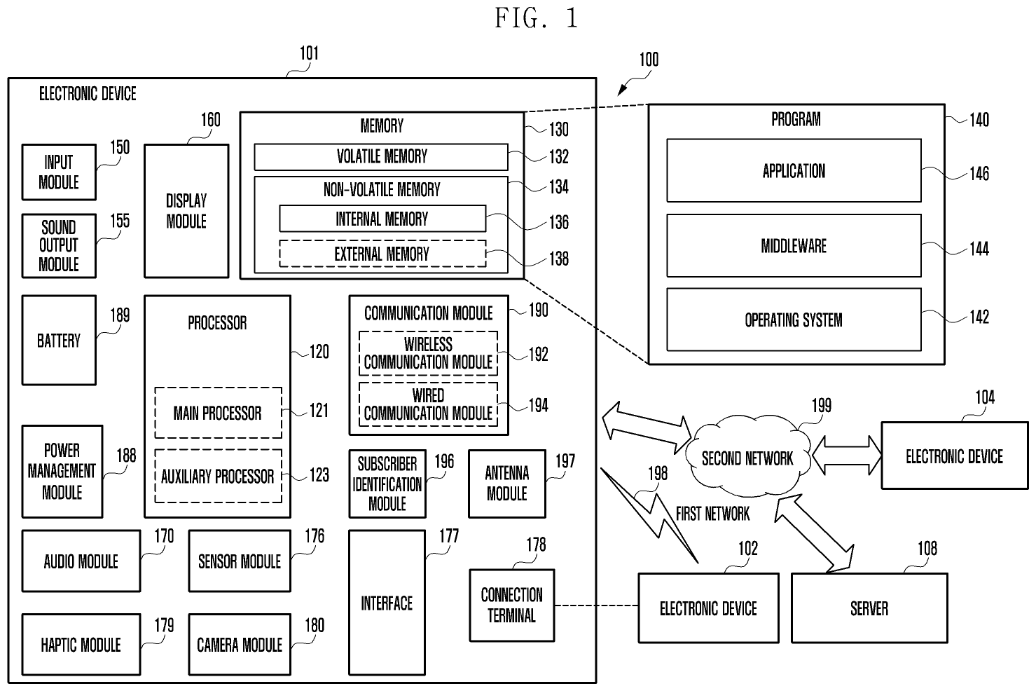

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element composed of a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

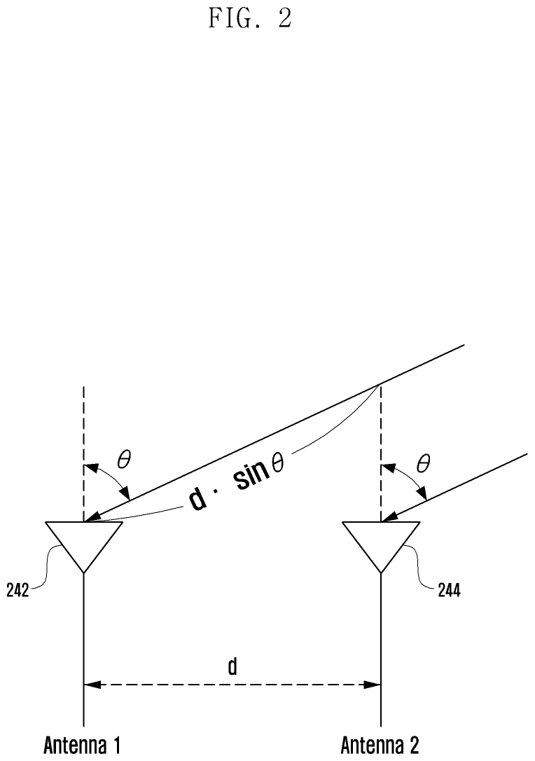

FIG. 2 is a view illustrating an embodiment of determining an angle of arrival of a signal transmitted by an external electronic device in an electronic device according to an embodiment of the disclosure.

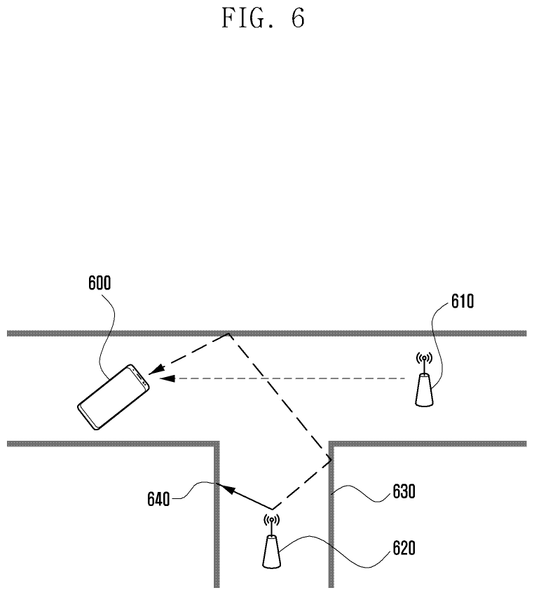

Referring to FIG. 2, antennas (e.g., a first antenna 242 and a second antenna 244), (e.g., the antenna module 197 of FIG. 1) included in an electronic device (e.g., the electronic device 101 of FIG. 1) are illustrated. According to an embodiment of the disclosure, a processor (e.g., the processor 120 of FIG. 1) may identify an angle of arrival (AoA) of a signal transmitted by an external electronic device (e.g., the first external electronic device 610 or the second external electronic device 620 of FIG. 6) based on a phase difference between signals received by the first antenna 242 and the second antenna 244. The external electronic device may include, for example, one of an AP, an anchor, a tag, or a beacon. The following description assumes that the external electronic device is an AP, but the external electronic device may include any device that transmits a signal capable of identifying a location, and is not limited to an AP.

According to an embodiment of the disclosure, the first antenna 242 and the second antenna 244 may receive signals transmitted from an external electronic device (e.g., the first external electronic device 610 or the second external electronic device 620 of FIG. 6). The phases of the signals received by the first antenna 242 and the second antenna 244 may be different from each other. For example, the signal received by the first antenna 242 may advance by d*sin(θ) more than the signal received by the second antenna 244.

According to an embodiment of the disclosure, the processor 120 may identify the difference in phases of signals received by the first antenna 242 and the second antenna 244, and identify the angle of arrival based on the difference in phases.

According to an embodiment of the disclosure, the processor 120 may transmit signals in various directions to an external electronic device instead of a phase difference value, and receive signals output from the external electronic device. The processor 120 may identify the strength of the received signal and determine a direction corresponding to the signal having the greatest strength among the identified signal strengths as the angle of arrival.

According to an embodiment of the disclosure, the processor 120 may identify the distance of the transmission path of a first signal and the distance of the transmission path of a second signal based on whether the angle of arrival of the signal transmitted by the external electronic device is within a specific range.

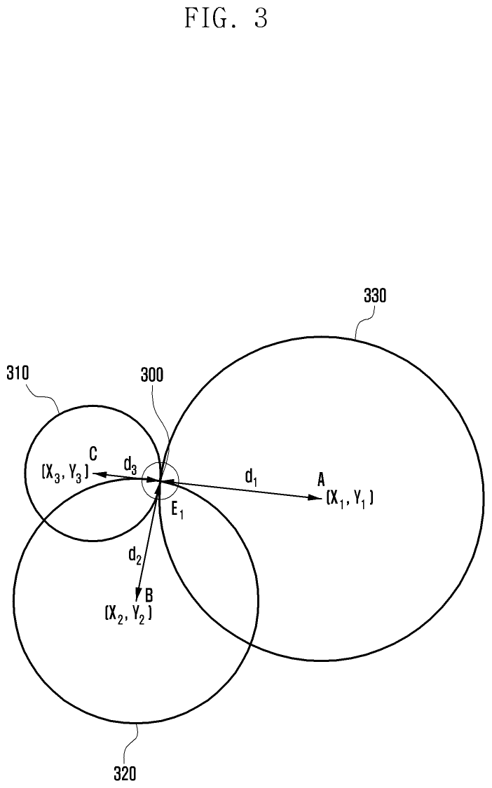

FIG. 3 a view illustrating a method of measuring a location of an electronic device according to an embodiment of the disclosure.

Referring to FIG. 3, a processor (e.g., the processor 120 of FIG. 1) may estimate the location of the electronic device 101 by using an electronic device (e.g., the electronic device 101 of FIG. 1) and a plurality of external electronic devices (e.g., AP). The processor 120 may configure a first circle 310 with the location of a first external electronic device (e.g., C) as the center and the distance (e.g., d3) from the electronic device 101 as the radius. The processor 120 may configure a second circle 320 with the location of a second external electronic device (e.g., B) as the center and the distance (e.g., d2) from the electronic device 101 as the radius. The processor 120 may configure a third circle 330 with the location of a third external electronic device (e.g., A) as the center and the distance (e.g., d1) from the electronic device 101 as the radius. The processor 120 may estimate an intersection 300 of the first circle 310, the second circle 320, and the third circle 330 as the location of the electronic device.

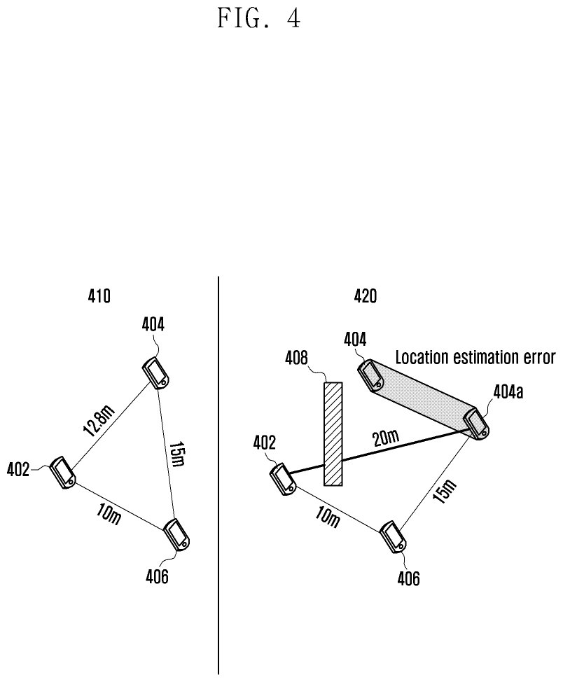

FIG. 4 is a view illustrating a situation in which an obstacle exists in a situation of measuring a location of an electronic device according to an embodiment of the disclosure.

As mentioned in FIG. 3, a processor (e.g., the processor 120 of FIG. 1) may estimate the location of at least one external electronic device by using a plurality of external electronic devices (e.g., a first external electronic device 402, a second external electronic device 404, and a third external electronic device 406). Drawing 410 illustrates a situation of estimating the location of at least one of the external electronic devices by using a plurality of external electronic devices (e.g., the first external electronic device 402, the second external electronic device 404, and the third external electronic device 406). Hereinafter, it is assumed that there are three external electronic devices used for location measurement, but the number of external electronic devices used for location measurement is not limited thereto.

Referring to FIG. 4, in the drawing 420, an obstacle 408 may be located between the first external electronic device 402 and the second external electronic device 404. When an obstacle exists between some of the external electronic devices among the plurality of external electronic devices used for location measurement, an error may occur in location estimation. The time for the signal transmitted from the first external electronic device 402 to reach the second external electronic device 404 may be delayed due to the obstacle 408. The processor 120 may estimate the location of the second external electronic device 404 based on the arrival times of the signals transmitted from the first external electronic device 402 and the third external electronic device 406. The processor 120 may incorrectly estimate the location of the second external electronic device 404 as another point 404a due to the obstacle 408.

An electronic device according to various embodiments of the disclosure may exclude the external electronic device (e.g., the first external electronic device 402) that causes an error in location estimation due to the influence of the obstacle 408 from the location estimation, and increase the accuracy of location estimation by using only the selected external electronic devices.

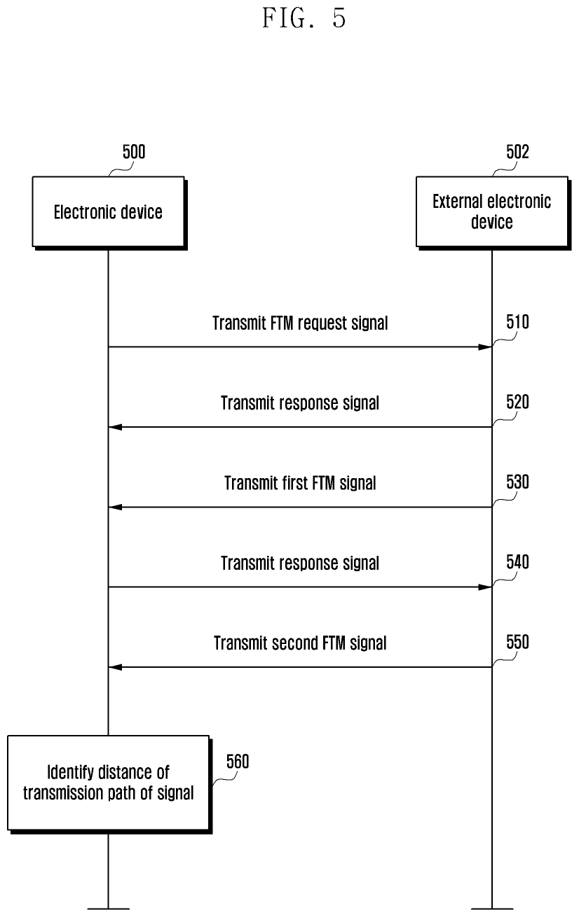

FIG. 5 is a view illustrating an embodiment of determining a distance to an external device by using a fine timing measurement (FTM) in an electronic device according to an embodiment of the disclosure.

Referring to FIG. 5, operations for measuring a movement distance of a first signal between an electronic device 500 (e.g., the electronic device 101 of FIG. 1) and an external electronic device 502 (e.g., the external electronic device 102 of FIG. 1) are illustrated.

According to an embodiment of the disclosure, in operation 510, the electronic device 500 may transmit an FTM request signal to the external electronic device 502.

According to an embodiment of the disclosure, in operation 520, the external electronic device 502 may transmit a response signal in response to receiving the FTM request signal transmitted by the electronic device 500.

According to an embodiment of the disclosure, in operation 530, a first FTM signal for measuring the movement distance of the first signal transmitted between the electronic device 500 and the external electronic device 502 may be transmitted. The first FTM signal may refer to the first signal, and may refer to the first signal in a method of measuring a transmission path of a signal by using a precise timing measurement method.

According to an embodiment of the disclosure, the external electronic device 502 may transmit the first FTM signal including the transmission time t1 of the first FTM signal.

According to an embodiment of the disclosure, in operation 540, the electronic device 500 may transmit a response signal in response to receiving the first FTM signal.

According to an embodiment of the disclosure, while transmitting the response signal, the electronic device 500 may identify the time t2 at which the first FTM signal is received and the time t3 at which the response signal is transmitted.

According to an embodiment of the disclosure, in operation 550, the external electronic device 502 may transmit the second FTM signal in response to receiving the response signal transmitted by the electronic device 500. The second FTM signal may refer to the first signal, and may refer to the first signal in a method of measuring a transmission path of a signal by using a precise timing measurement method.

According to an embodiment of the disclosure, the external electronic device 502 may transmit the second FTM signal including the time t4 at which the external electronic device receives the response signal transmitted by the electronic device in operation 540.

According to an embodiment of the disclosure, in operation 560, the electronic device 500 may identify the distance of the transmission path of the first signal based on t1 to t4.

According to an embodiment of the disclosure, the electronic device 500 (or the processor 710) may determine a value obtained by multiplying half of the difference value (e.g., (t4−t1)−(t3−t2)) of the first difference value (e.g., t4−t1), which is the difference value between the time t4 when the external electronic device 502 receives the response signal and the time t1 when the external electronic device 502 transmits the first FTM signal, and the second difference value (e.g., t3−t2), which is the difference value between the time t3 when the electronic device 500 transmits the response signal and the time t2 when the electronic device 500 receives the first FTM signal, by the first FTM signal speed (e.g., light speed) as the distance of the transmission path of the first signal.

According to another embodiment of the disclosure, the electronic device 500 (or the processor 710) may determine a value obtained by multiplying the average of the difference values (e.g., t2−t1) between the time t2 when the electronic device 500 receives the first FTM signal and the time t1 when the external electronic device 502 transmits the first FTM signal and the difference values (e.g., t4−t3) between the time t4 when the external electronic device 502 receives the response signal and the time t3 when the electronic device 500 transmits the response signal by the first FTM signal speed (e.g., light speed) as the distance of the transmission path of the first signal.

FIG. 6 is a view illustrating an embodiment in which an electronic device determines a location of the electronic device according to an embodiment of the disclosure.

Referring to FIG. 6, according to an embodiment of the disclosure, an electronic device 600 (e.g., the electronic device 101 of FIG. 1) may establish a connection with a first external electronic device 610 or a second external electronic device 620 (e.g., an access point (AP)) and exchange signals. The electronic device 600 may determine the location of the electronic device 600 based on location information of at least one external electronic device received from the first external electronic device 610 or the second external electronic device 620 (e.g., an access point (AP)) and relative location information between the electronic device 600 and at least one external electronic device.

According to an embodiment of the disclosure, the electronic device 600 may determine the location of the electronic device 600 based on location information of an AP in which an LoS path is generated between the electronic device 600 and the first external electronic device 610 or the second external electronic device 620 and relative location information between the electronic device 600 and the AP. The LoS path may refer to a line of sight (LoS) in which an electronic device and an external electronic device are connected by a virtual straight line. Alternatively, the LoS path may refer to a path in which the first external electronic device 610 and the second external electronic device 620 are connected by a virtual straight line.

According to an embodiment of the disclosure, the electronic device 600 may receive a first signal transmitted by the first external electronic device 610, and identify the distance of the transmission path of the first signal based on the difference between the transmission time of the first signal and the reception time of the first signal. For example, the electronic device 600 may identify the distance of the transmission path of the first signal using the FTM method illustrated in FIG. 5. The electronic device 600 may transmit a request signal of the first signal to the first external electronic device 610 to identify the distance of the transmission path of the first signal. The first external electronic device 610 may transmit the first signal to the electronic device 600 in response to receiving the request signal of the first signal. The first signal may include time information on the time at which the first external electronic device 610 receives the request signal of the first signal. The electronic device 600 may determine the distance of the transmission path of the first signal based on the difference between the time at which the first external electronic device 610 receives the request signal of the first signal and the time at which the electronic device 600 receives the first signal.

According to an embodiment of the disclosure, the electronic device 600 may output a second signal, and identify the distance of the transmission path of the second signal based on the difference between the reception time of a third signal, which is a signal reflected by an external object (the first external electronic device 610), and the output time of the second signal. The electronic device 600 may determine that the transmission path of the first signal is a LOS path between the first external electronic device 610 and the electronic device 600 based on the difference between the distance of the transmission path of the first signal and the distance of the transmission path of the second signal.

The electronic device 600 may transmit the request signal of the first signal to the second external electronic device 620 to identify the distance of the transmission path of the first signal. The second external electronic device 620 may transmit the first signal to the electronic device 600 in response to receiving the request signal of the first signal. According to an embodiment of the disclosure, the electronic device 600 may receive the first signal transmitted by the second external electronic device 620, and identify the distance of the transmission path of the first signal based on the difference between the transmission time of the first signal and the reception time of the first signal. The electronic device 600 may output a second signal, and identify the distance of the transmission path of the second signal based on the difference between the reception time of a third signal, which is a signal reflected by an external object 630, and the output time of the second signal. The electronic device 600 may determine that the transmission path of the first signal is not an LoS path between the second external electronic device 620 and the electronic device 600 based on the difference between the distance of the transmission path of the first signal and the distance of the transmission path of the second signal. The electronic device 600 may determine that an external object 640 exists between the second external electronic device 620 and the electronic device 600.

According to an embodiment of the disclosure, the electronic device 600 may generate relative location information between the first external electronic device 610 and the electronic device 600 based on the distance (e.g., the distance of the transmission path of the first signal or the distance of the transmission path of the second signal) between the first external electronic device 610 and the electronic device 600 for which the LoS path is generated and the distance (e.g., the angle of arrival of the first signal) between the first external electronic device 610 and the electronic device 600. The electronic device 600 may determine the location of the electronic device 600 based on the location information of the first external electronic device 610 and the relative location information between the first external electronic device 610 and the electronic device 600. The electronic device 600 may also determine the location of the electronic device 600 based on the location information of the second external electronic device 620 and the relative location information between the second external electronic device 620 and the electronic device 600. In FIG. 6, the external object 640 disposed between the electronic device 600 and the second external electronic device 620 may form a non-line-of-sight (NLoS) environment. The electronic device 600 may have difficulty in distinguishing the multipath signals due to the NLoS. As a result, the location of the electronic device 600 may have a large error.

In an embodiment of the disclosure, the communication channel capacity available in RTLS may be limited. For example, Wi-Fi using the 2.4 GHz band has 14 channels, and if it is used with a bandwidth of 20 MHz, the number of bands that may be operated simultaneously without interference may be only about 3 to 4. In RTLS using the 802.11mc FTM protocol, there may be a disadvantage in that Wi-Fi frames must be exchanged at least 2 to tens of times to obtain a distance measurement value between a mobile object and an AP. As a result, the number of distance estimations that the electronic device 600 may perform per unit time may be limited. When the electronic device 600 uses a wide bandwidth for precise distance estimation, the operation of the FTM protocol may fail or the network performance of the user using the corresponding channel may be significantly degraded. In addition, as the number of AP devices used increases, the number of RTT signals that may be received from one AP device may decrease.

An electronic device (e.g., the electronic device 101 of FIG. 1) according to an embodiment of the disclosure may improve the efficiency of network resources in a mobile area and reduce the distance calculation error between a mobile electronic device and a plurality of fixed APs in configuring RTLS, thereby improving the location estimation result of the electronic device.

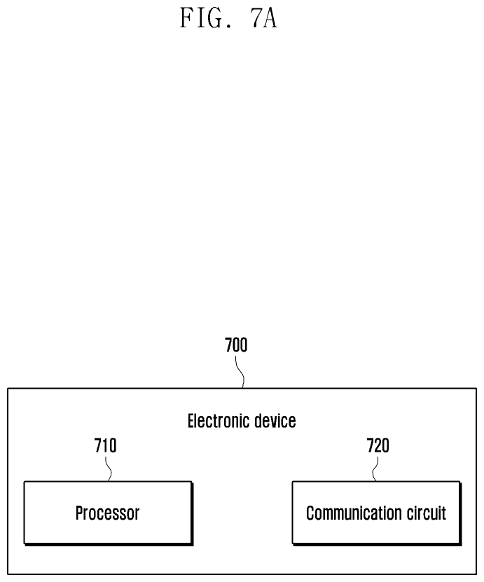

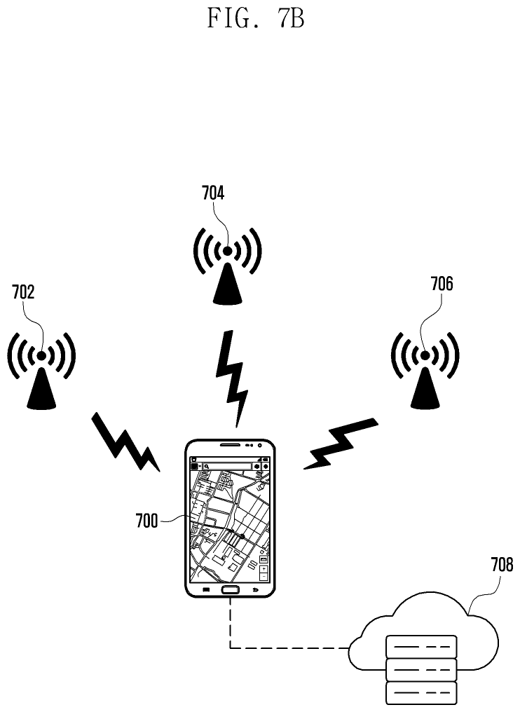

An electronic device according to an embodiment may estimate the location of the electronic device after collecting distance information by selecting only APs that are close to the electronic device based on map information. The electronic device according to an embodiment may additionally select only APs with a distance error below a certain level and correct the location of the electronic device to improve the location estimation result of the electronic device. Hereinafter, the configuration and operation of an electronic device (e.g., an electronic device 700 of FIG. 7A) for improving a location estimation result will be described.

FIG. 7A is a block diagram illustrating a configuration of an electronic device according to an embodiment of the disclosure.

Referring to FIG. 7A, according to various embodiments of the disclosure, the electronic device 700 may include a processor 710, and some of the illustrated configurations may be omitted or replaced. The electronic device 700 may include at least some of the configurations and/or functions of the electronic device 101 of FIG. 1. At least some of the respective configurations of the illustrated (or not illustrated) electronic device may be operatively, functionally, and/or electrically connected to each other.

In an embodiment of the disclosure, the processor 710 is configured to perform operations or data processing related to control and/or communication of each component of the electronic device 700, and may be configured with one or more processors. The processor 710 may include at least some of the configurations and/or functions of the processor 120 of FIG. 1.

In an embodiment of the disclosure, the operation and data processing functions that the processor 710 may implement on the electronic device 700 are not limited, but features related to the location measurement of the electronic device 700 will be described below. The operations of the processor 710 may be performed by loading instructions stored in memory (e.g., the memory 130 of FIG. 1).

In an embodiment of the disclosure, a communication module 720 may communicate with an external device through a wireless network under the control of the processor 710. The communication module 720 may include hardware and software modules for transmitting and receiving data from a cellular network (e.g., a long term evolution (LTE) network, a 5G network, a new radio (NR) network) and a short-range network (e.g., Wi-Fi, Bluetooth, BLE, UWB, Zigbee, or RFID). The communication module 720 may include at least some of the configurations and/or functions of the communication module 190 of FIG. 1.

In an embodiment of the disclosure, the electronic device 700 (e.g., the electronic device 101 of FIG. 1) may transmit or receive data to or from an external electronic device (e.g., AP, anchor, tag, beacon) located in a preconfigured range based on the electronic device 700. Hereinafter, it is assumed that the external electronic device is an AP, but the external electronic device may include any devices (e.g., large home appliance) that transmits a signal capable of specifying a location, and is not limited to the AP. The electronic device 700 may identify whether an external electronic device (e.g., an AP) exists within a preconfigured range by using the angle of arrival (AoA) of a signal transmitted by the external electronic device. The electronic device 700 may transmit data or receive data to or from an external electronic device in which the angle of arrival (AoA) of a signal transmitted from a specific external electronic device is included within a specific range.

According to an embodiment of the disclosure, the electronic device 700 may identify the movement distance of the signal based on the reception direction of the signal or the difference between the transmission time and the reception time of the signal while transmitting and receiving the signal with the external electronic device. The electronic device 700 may identify relative location information between the external electronic device and the electronic device 700 based on the reception direction of the signal and the movement distance of the signal. The electronic device 700 may perform various operations (e.g., control of an external electronic device or generation of an indoor map including location information of the external electronic device) based on the identified relative location information.

According to an embodiment of the disclosure, the processor 710 may determine the location of the electronic device 700 by using information on a mobile area including a location where a plurality of APs are installed. The processor 710 may receive map information of the mobile area from a user or an external device (e.g., an application server or another electronic device (e.g., the external electronic device 102 of FIG. 1) to determine the location of the electronic device 700. The RTLS service application in the electronic device 700 may receive map information from a server or a cloud and transmit the map information to the RTLS framework part when operating the RTLS service.

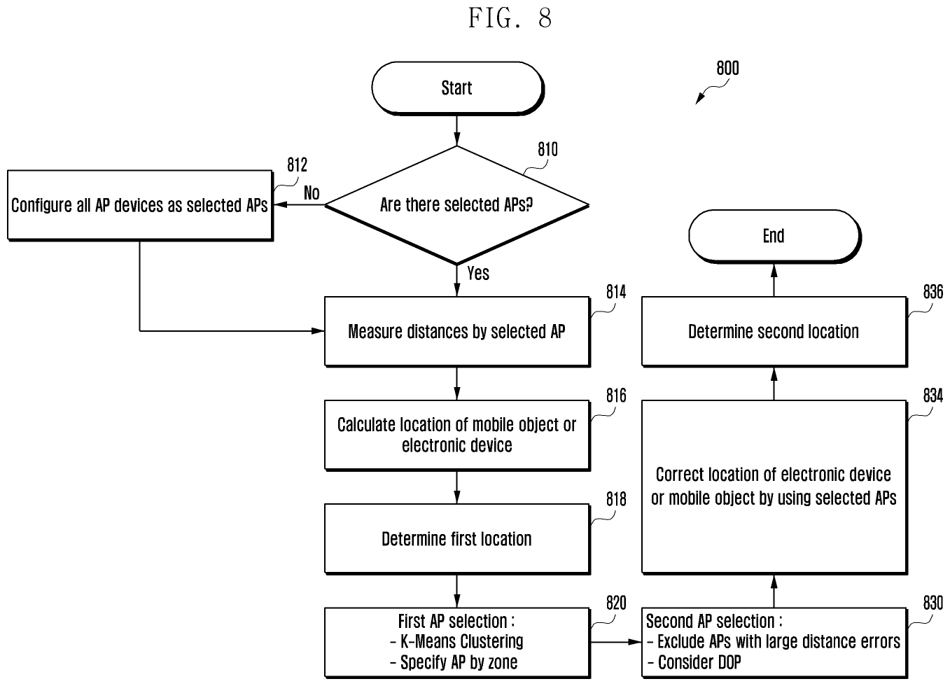

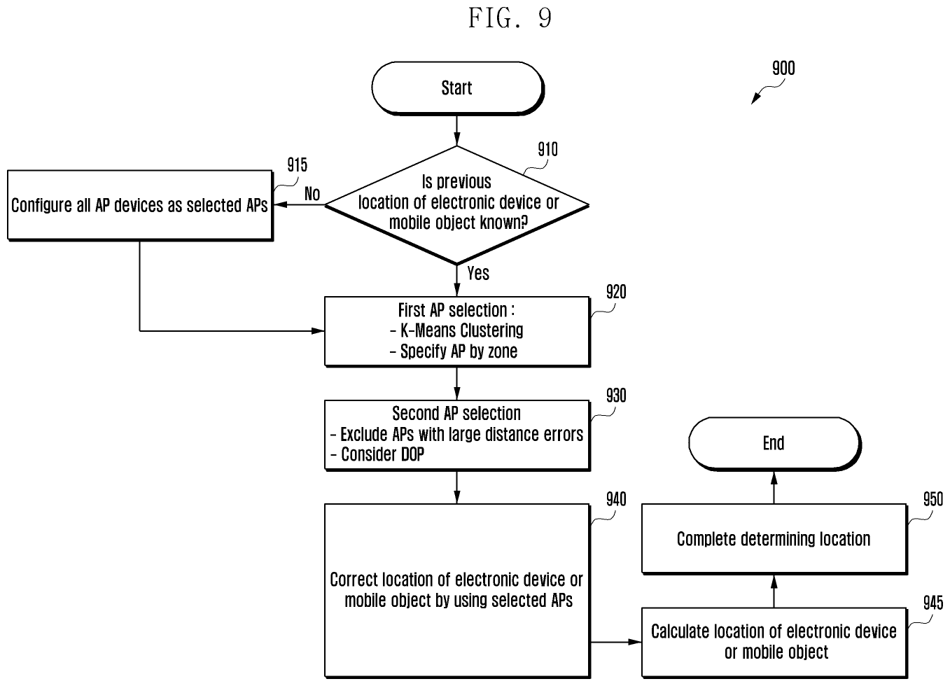

According to an embodiment of the disclosure, real-time location calculation may be delayed by the time required to process signals transmitted by APs as the number of APs used to measure the location of the electronic device 700 exceeds a certain level. The processor 710 may select APs for accurate and rapid location calculation. The processor 710 may select APs that are close to the current location of the electronic device 700, which is a mobile object, based on the map information during a first AP selection process. The processor 710 may require at least three APs to determine the location of the electronic device 700. The first AP selection process will be described in FIG. 8. The processor 710 may also use a scoring system to select APs. The scoring system will be described in FIG. 9.

According to an embodiment of the disclosure, the processor 710 may select APs and receive multiple signals from the selected APs to calculate the distance to the electronic device 700. The processor 710 may calculate the distance between the electronic device 700 and an AP by using a log-distance path loss model or a fingerprint method for a mobile area. The log-distance path loss model may refer to a model that predicts signal loss in an indoor or densely populated area. The fingerprint method may refer to a method that utilizes noise and surrounding environment information for location tracking. The fingerprint method may refer to a method that randomly selects multiple locations in advance in a service area and estimates the location by using signal strength information collected from the selected locations.

According to an embodiment of the disclosure, the processor 710 may calculate the real-time location of the electronic device 700 or the mobile object based on the distance information of the collected APs. The processor 710 may use the triangulation or trilateration method to calculate the location of the electronic device 700. The triangulation or trilateration method will be described in FIGS. 8 and 9.

According to an embodiment of the disclosure, the processor 710 may exclude APs with low performance among the APs used for positioning calculation. The processor 710 may recalculate the location of the electronic device 700 by using the selected APs. The processor 710 may consider the arrangement situation of each AP centered on the electronic device 700 in a situation where selection of APs is difficult due to a small error between APs or the number of APs to be selected needs to be adjusted. The processor 710 may perform a second AP selection process based on the dilution of precision (DoP) of the APs. The processor 710 may perform relatively better positioning performance in an environment in which APs are spread than in an environment in which APs are concentrated in one direction based on the electronic device 700. The processor 710 may perform the second AP selection process based on the dilution of precision (DoP). The DoP may be a value indicating the degree to which APs to be calculated are distributed unevenly. According to an example, as a plurality of APs are unevenly distributed in a specific area, the DoP may increase, and as the plurality of APs are evenly distributed, the DoP may be small. According to an example, the processor 710 may identify DoPs of the plurality of APs and select a second AP based on the DoP. The processor 710 may select the AP used to determine the DoP as the second AP based on identifying that the DoP is less than or equal to (or, less than) a specified value. The processor 710 may select APs existing in various directions through the second AP selection process. The DoP will be described in FIG. 8.

According to an embodiment of the disclosure, the processor 710 may calculate a score based on at least one of an RSSI value, a distance estimation value between the electronic device and the corresponding AP, or the number of non-response of the corresponding AP, and select APs based on the corresponding score. The score-based AP selection process will be described in FIG. 9.

According to an embodiment of the disclosure, the processor 710 may select APs based on the score. The processor 710 may perform positioning calculation again by using the selected APs. The processor 710 may determine the recalculated location of the electronic device 700 as the final location. The processor 710 may transmit the recalculated final location of the electronic device 700 to an RTLS service application, and control the RTLS service application so that the user may recognize the final location. The processor 710 may select APs for calculating the next location of the electronic device 700 by using the information on the final location and the map information. The processor 710 may determine the real-time location of the electronic device 700 by using the newly selected APs.

FIG. 7B is a view illustrating a network configuration of a real-time location system (RTLS) in an electronic device according to an embodiment of the disclosure.

Referring to FIG. 7B, according to an embodiment of the disclosure, the electronic device 700 may include a real-time location system (RTLS). The real-time location system (RTLS) may be configured in various forms considering the characteristics of the mobile object requiring tracking and the mobile area. For example, the real-time location system (RTLS) may be formed based on a network composed of a mobile electronic device and fixed AP devices, as illustrated in FIG. 7B. Alternatively, the real-time location system (RTLS) may be disposed in an environment where there is an obstacle (e.g., a wall) between the mobile electronic device and the fixed AP devices within the mobile area. In this case, the real-time location system (RTLS) may first require map information on the mobile area in order to determine the real-time location of the electronic device.

Referring to FIG. 7B, the electronic device 700 may receive signals from a plurality of AP devices 702, 704, and 706 and perform a real-time positioning operation based on map information received from an external device 708 (e.g., a server). According to an embodiment of the disclosure, the processor 710 may include a communication technology control part including at least one of Bluetooth, BLE, Wi-Fi, or UWB, an RTLS framework part responsible for location measurement, and an RTLS service application part receiving input/output from a user. The processor 710 may transmit map information received from the RTLS service application part to the RTLS framework part. The processor 710 may transmit data on the external environment received from the communication technology control part to the RTLS framework part. The processor 710 may process data on the external environment by using the RTLS framework part and calculate the distance to the plurality of AP devices 702, 704, and 706. The processor 710 may determine the location of the electronic device 700 by using the distance to the plurality of AP devices 702, 704, and 706.

FIG. 8 is a flowchart illustrating a method of measuring a location of an electronic device according to an embodiment of the disclosure.

Referring to FIG. 8, the operations may be implemented based on instructions that may be stored in a computer recording medium or memory (e.g., the memory 130 of FIG. 1). The illustrated method 800 may be executed by the electronic device (e.g., the electronic device 101 of FIG. 1 and the electronic device 700 of FIG. 7A) described with reference to FIGS. 1 to 6, 7A, and 7B, and the technical features described above will be omitted below. The order of each operation of FIG. 8 may be changed, some operations may be omitted, and some operations may be performed simultaneously.

According to an embodiment of the disclosure, in operation 810, a processor (e.g., the processor 710 of FIG. 7A) may identify whether selected access points (APs) exist.

In operation 812, the processor 710 may determine all access points (APs) from which signals are identified as selected APs based on the absence of selected access points (APs).

In operation 814, the processor 710 may measure distances between the selected APs and the electronic device 700. In operation 816, the processor 710 may use at least one of the triangulation technique or the trilateration technique to calculate the location of the mobile object including the electronic device 700. The processor 710 may perform triangulation by using direction or angle information on APs centered on the electronic device 700. The processor 710 may perform trilateration by using distance information on the APs. The processor 710 may use either a particle filter or a Kalman filter to minimize an error in calculating the location of the electronic device 700. The particle filter may refer to a tool that estimates an actual location by using data measured in a noisy environment and a filter. The Kalman filter may refer to a tool that estimates a joint distribution of a current state variable based on a measured value performed in the past.

In operation 818, the processor 710 may determine a first location of the electronic device 700 through operations 814 and 816. The first location may refer to a location of the electronic device 700 determined by using selected APs or all APs. The processor 710 may receive signals from a plurality of AP devices and calculate a location based on the signals.

In operation 820, the processor 710 may perform a first AP selection process. According to an embodiment of the disclosure, the processor 710 may determine how many APs to receive signals from or how long interval to receive signals from each AP. The number of APs receiving signals or the signal reception intervals from the APs may directly affect the location calculation of the electronic device 700. If the number of APs used by the electronic device 700 exceeds a certain number, the number of signals (sample rate) that may be received from one AP decreases, which may delay real-time location calculation. Accordingly, the processor 710 may select APs for accurate and rapid location measurement. The processor 710 may perform selection based on the current location of the mobile electronic device 700 and map information of nearby APs in the first AP selection process. According to an embodiment of the disclosure, the processor 710 may determine an AP candidate group expected to perform good positioning performance as the first group based on the arrangement environment and distance between the electronic device 700 and the AP. The number of APs required to determine the location of the electronic device may be at least three or more. The processor 710 may quickly select APs so as not to affect a subsequent positioning operation. For example, the processor 710 may utilize a k-means clustering technique or a zone matching technique in the first AP selection process. The k-means clustering technique may refer to an algorithm for grouping given data into k clusters. The k-means clustering technique may operate in a way that minimizes the variance of the distance difference between each cluster. The zone matching technique may refer to a way of dividing a map into several zones and then selecting APs in the zone where the coordinates of the electronic device 700 are located on the map information. According to an embodiment of the disclosure, the map information received by the electronic device 700 from an external device (e.g., an application server or another electronic device (e.g., the external electronic device 102 of FIG. 1)) to determine the location of the electronic device 700 may include zone information based on the k-means clustering technique or the zone matching technique.

In operation 830, the processor 710 may perform a second AP selection process. The processor 710 may compare the distance to the AP calculated based on the first location of the electronic device 700 determined in operation 818, and the distance between the electronic device 700 and the AP calculated on the map information. According to an embodiment of the disclosure, the processor 710 may determine an AP for which the distance to the AP calculated based on the first location of the electronic device 700 and the distance between the electronic device 700 and the AP calculated on the map information are less than a certain level as a second group. According to an embodiment of the disclosure, the processor 710 may perform the second AP selection process based on the dilution of precision (DoP) of the APs. The processor 710 may perform relatively better positioning performance in an environment in which APs are spread than in an environment in which APs are concentrated in one direction based on the electronic device 700. The processor 710 may determine whether the APs are concentrated in one direction or spread out based on the dilution of decision (DoP).

In operation 834, the processor 710 may measure the location of the electronic device 700 or the mobile object by using the APs determined as the second group. The processor 710 may correct the location of the electronic device 700 or the mobile object by using the APs determined as the second group. For example, the processor 710 may use either the triangulation technique or the trilateration technique, as in operation 816. In operation 836, the processor 710 may determine a second location of the electronic device 700 based on the APs in the second group. In an embodiment of the disclosure, the processor 710 may determine at least one AP located within a certain distance from the second location of the electronic device 700 as a third group among the plurality of APs based on the map information. The processor 710 may determine a third distance between the AP in the third group and the electronic device 700 based on a signal received from the AP in the third group. The processor 710 may determine a fourth distance between the AP in the third group and the electronic device 700 based on the map information. The processor 710 may determine an AP among at least one AP in the third group, in which the difference between the third distance and the fourth distance is less than a certain level, as a fourth group. The processor 710 may determine a third location of the electronic device using the AP in the fourth group.

FIG. 9 is a flowchart illustrating a method of measuring a location of an electronic device according to an embodiment of the disclosure.

Referring to FIG. 9, the operations may be implemented based on instructions that may be stored in a computer recording medium or memory (e.g., the memory 130 of FIG. 1). The illustrated method 900 may be executed by the electronic device (e.g., the electronic device 700 of FIG. 7A) described with reference to FIGS. 1 to 6, 7A, and 7B, and the technical features described above will be omitted below. The order of each operation of FIG. 9 may be changed, some operations may be omitted, and some operations may be performed simultaneously.

In operation 910, the processor (e.g., the processor 710 of FIG. 7A) may determine whether the previous location of the electronic device 700 or the mobile object is recorded on the memory 130. The previous location may refer to the location of the electronic device 700 or the mobile object recorded on the map information before performing the positioning operation. Alternatively, the previous location may refer to the location of the electronic device 700 or the mobile object determined while performing the operation of FIG. 8. The previous location of the electronic device 700 or the mobile object may not exist when the location measurement method is first executed.

In operation 915, the processor 710 may determine all access points (APs) from which signals are identified as selected APs based on the fact that the previous location of the electronic device 700 is not recorded on the memory 130. The processor 710 may determine all access points (APs) from which signals are identified as selected APs based on the fact that the previous location of the electronic device is not known, and in operation 940, may measure the distance to the electronic device 700 for each AP.

In operation 820, the processor 710 may perform a first AP selection process. According to an embodiment of the disclosure, the processor 710 may determine how many APs to receive signals from or how long interval to receive signals from each AP. The number of APs receiving signals or the signal reception intervals from the APs may directly affect the location calculation of the electronic device 700. If the number of APs used by the electronic device 700 exceeds a certain number, the number of signals (sample rate) that may be received from one AP decreases, which may delay real-time location calculation. Accordingly, the processor 710 may select APs for accurate and rapid location measurement. According to an embodiment of the disclosure, the processor 710 may perform selection based on the current location of the mobile electronic device 700 and map information of nearby APs in the first AP selection process. The processor 710 may determine an AP candidate group expected to perform good positioning performance as the first group based on the arrangement environment and distance between the electronic device 700 and the AP. The number of APs required to determine the location of the electronic device may be at least three or more. The processor 710 may quickly select APs so as not to affect a subsequent positioning operation. For example, the processor 710 may utilize a k-means clustering technique or a zone matching technique in the first AP selection process. The k-means clustering technique may refer to an algorithm for grouping given data into k clusters. The k-means clustering technique may operate in a way that minimizes the variance of the distance difference between each cluster. The zone matching technique may refer to a way of dividing a map into several zones and then selecting APs in the zone where the coordinates of the electronic device 700 are located on the map information.

In operation 930, the processor 710 may perform a second AP selection process. According to an embodiment of the disclosure, the processor 710 may compare the distance to the AP calculated based on the first location of the electronic device 700 and the distance between the electronic device 700 and the AP calculated on the map information. The first location may refer to a location of the electronic device 700 determined by using selected APs or all APs. The first location may be determined differently from the location of the electronic device 700 calculated on the map information. According to an embodiment of the disclosure, the processor 710 may determine an AP for which the distance to the AP calculated based on the first location of the electronic device 700 and the distance between the electronic device 700 and the AP calculated on the map information are less than a certain level as a second group.

According to an embodiment of the disclosure, the processor 710 may perform the second AP selection process based on the dilution of precision (DoP) of the APs. The processor 710 may perform relatively better positioning performance in an environment in which APs are spread than in an environment in which APs are concentrated in one direction based on the electronic device 700. According to an embodiment of the disclosure, the processor 710 may perform the second AP selection process based on the dilution of precision (DoP). The DoP may be a value indicating the degree to which APs to be calculated are distributed unevenly. According to an example, as a plurality of APs are unevenly distributed in a specific area, the DoP may increase, and when the plurality of APs are evenly distributed, the DoP may be small. According to an example, the processor 710 may identify DoPs of the plurality of APs and select a second AP based on the DoP. The processor 710 may select the AP used to determine the DoP as the second AP based on identifying that the DoP is less than or equal to (or, less than) a specified value. The processor 710 may select APs existing in various directions through the second AP selection process.

In operation 940, the processor 710 may use the APs determined as the second group to measure the location of the electronic device 700. The processor 710 may measure the distance to the electronic device 700 for each AP determined as the second group. The processor 710 may correct the location of the electronic device 700 or the mobile object by using the APs determined as the second group.

In operation 945, according to an example, the processor 710 may use at least one of the triangulation technique or the trilateration technique to calculate the location of the mobile object including the electronic device 700. For example, the processor 710 may perform triangulation by using direction or angle information on APs centered on the electronic device 700. For example, the processor 710 may perform trilateration by using distance information on the APs. According to an embodiment of the disclosure, the processor 710 may use either a particle filter or a Kalman filter to minimize an error in calculating the location of the electronic device 700. The particle filter may refer to a tool that estimates an actual location by using data measured in a noisy environment and a filter. The Kalman filter may refer to a tool that estimates a joint distribution of a current state variable based on a measured value performed in the past.

In operation 950, the processor 710 may determine a second location of the electronic device 700 based on the APs in the second group.

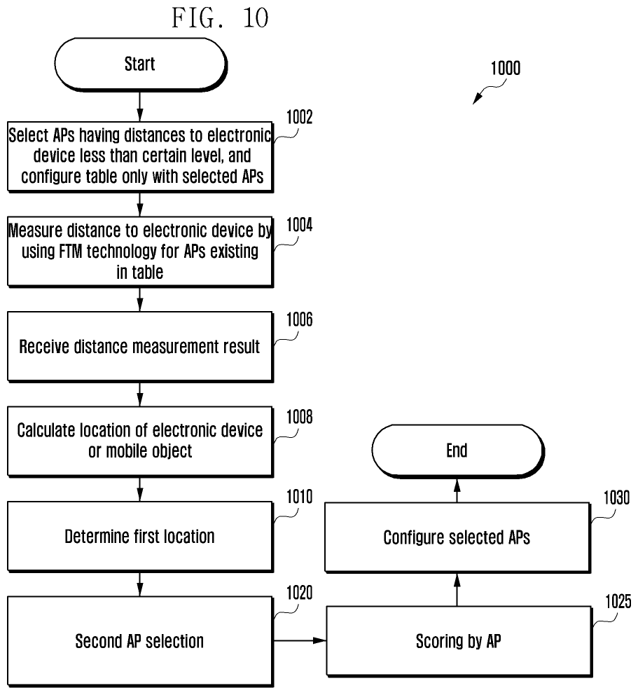

FIG. 10 is a flowchart illustrating a method of measuring a location of an electronic device according to an embodiment of the disclosure.

Referring to FIG. 10, the operations may be implemented based on instructions that may be stored in a computer recording medium or memory (e.g., the memory 130 of FIG. 1). The illustrated method 1000 may be executed by the electronic device (e.g., the electronic device 700 of FIG. 7A) described with reference to FIGS. 1 to 6, 7A, and 7B, and the technical features described above will be omitted below. The order of each operation of FIG. 10 may be changed, some operations may be omitted, and some operations may be performed simultaneously.

In operation 1002, a processor (e.g., the processor 710 of FIG. 7A) may measure the distance to the electronic device 700 by using FTM technology for all APs. FTM may refer to a method of measuring the round-trip time by exchanging wireless signals between two Wi-Fi devices and multiplying the measured value by the speed of light to estimate the round-trip distance between the two devices. The processor 710 may select APs having distances less than a certain level to the electronic device 700, and configure a table only with the selected APs. Alternatively, the processor 710 may determine the selected APs as the first group.

In operation 1004, the processor 710 may measure the distance to the electronic device 700 by using FTM technology for APs existing in the table.

In operation 1006, the processor 710 may receive a distance measurement result for each AP existing in the table.

In operation 1008, according to an embodiment of the disclosure, the processor 710 may use at least one of a triangulation technique or a trilateration technique to calculate the location of the electronic device 700 or the mobile object. For example, the processor 710 may perform triangulation by using direction or angle information for a plurality of external electronic devices (e.g., the first external electronic device 702, the second external electronic device 704, or the third external electronic device 706 of FIG. 7B) centered on the electronic device 700. For example, the processor 710 may perform trilateration by using distance information for a plurality of external electronic devices (e.g., APs).

In operation 1010, the processor 710 may determine a first location of the electronic device 700 by using the plurality of external electronic devices (e.g., APs) existing in the table.

In operation 1020, the processor 710 may perform a second selection while determining the reliability of each AP. The processor 710 may use a scoring method in the second selection process.

For example, the processor 710 may perform the second selection for the AP based on the RSSI value. The received signal strength indicator (RSSI) may refer to strength of a received signal. The RSSI may transmit a strength from about −99 dBm to 35 dBm, and a higher number may refer to a stronger signal strength. In an embodiment of the disclosure, when the RSSI value at time t shows a sudden change compared to the RSSI value at the previous time t−1, the processor 710 may assign a specific score (e.g., −1) to the score of the corresponding AP. The sudden change may refer to a situation in which the amount of change exceeds a certain level. The score value assigned to the AP may vary depending on the configuration and may not be fixed. The time t is only an example, and the time at which the processor 710 selects the AP based on the RSSI value may not be fixed.

In an embodiment of the disclosure, the processor 710 may perform the second selection on the AP based on the amount of change in the distance measurement value between the AP and the electronic device 700. When the distance estimation value between the electronic device and the corresponding AP device at time t shows a sudden change compared to the time t−1, the processor 710 may assign a specific score (e.g., −1) to the score of the corresponding AP device. The sudden change may refer to a situation in which the amount of change exceeds a certain level. The score value assigned to the AP may vary depending on the configuration and may not be fixed. The time t is only an example, and the time at which the processor 710 selects the AP based on the distance measurement value may not be fixed.

In an embodiment of the disclosure, the processor 710 may perform the second selection on the AP based on the number of times of non-response to the request of the electronic device 700. The request of the electronic device 700 may refer to a signal transmission request for calculating a round-trip time (RTT). A specific score (e.g., −1) may be assigned to an AP that does not respond to the request of the electronic device 700 more than a certain number of times (e.g., n times). The certain number of times or the assigned score is not fixed and may vary depending on the configuration.

In operation 1025, the processor 710 may calculate a score for each AP by synthesizing the scores assigned to the APs in operation 1020.

In operation 1030, the processor 710 may select APs based on the calculated score. For example, the processor 710 may determine APs whose calculated scores exceed a certain level as a second group. The processor 710 may determine the location of the electronic device 700 by using the APs determined as the second group.

According to an embodiment of the disclosure, the processor 710 may measure the distance to the electronic device 700 for each AP determined as the second group. The operation of measuring the distance between the AP determined as the second group and the electronic device 700 may be performed based on operations 834 to 836 of FIG. 8 or operations 940 to 950 of FIG. 9.

According to an embodiment of the disclosure, an electronic device (e.g., the electronic device 500 of FIG. 5) may include a communication circuit (e.g., the communication circuit 720 of FIG. 7A) that communicates with an external electronic device (e.g., the external electronic device 502 of FIG. 5), memory (e.g., the memory 130 of FIG. 1) including map information including location information of a plurality of access points (APs) in a specific area, and a processor (e.g., the processor 710 of FIG. 7A). The processor 710 may determine, based on the map information, at least one AP located within a certain distance from a first location of the electronic device 500 among the plurality of APs as a first group, determine, based on a signal received from the AP in the first group, a first distance between an AP in the first group and the electronic device 500, determine, based on the map information, a second distance between the AP in the first group and the electronic device 500, determine an AP in which the difference between the first distance and the second distance is less than a certain level among at least one AP in the first group as a second group, and determine a second location of the electronic device 500 by using an AP in the second group. The first location may be determined based on a signal broadcast by the plurality of access points (APs) in the specific area.

According to an embodiment of the disclosure, the processor 710 may determine the first location by using all APs detected in the specific area.

According to an embodiment of the disclosure, the processor 710 may select an AP in the first group to be included in the second group based on at least one of a received signal strength indicator (RSSI) indicating the strength of a received signal, an estimated distance between the electronic device and the AP in the first group, or the number of non-response of the AP in the first group to a request from the electronic device.

According to an embodiment of the disclosure, the processor 710 may determine the score of an AP in the first group based on whether the RSSI is below a certain level, whether the change in the estimated distance between the electronic device and the AP in the first group exceeds a certain level, and/or whether the number of non-response times of the AP in the first group to a request from the electronic device exceeds a certain level, and select an AP in the first group to be included in the second group based on the determined score.

According to an embodiment of the disclosure, the processor 710 may determine, based on the map information, at least one AP located within a certain distance from the second location of the electronic device among the plurality of APs as a third group, determine, based on a signal received from the AP in the third group, a third distance between the AP in the third group and the electronic device, determine, based on the map information, a fourth distance between the AP in the third group and the electronic device, determine an AP in which the difference between the third distance and the fourth distance is less than a certain level among at least one AP in the third group as a fourth group, and determine a third location of the electronic device by using an AP in the fourth group.

According to an embodiment of the disclosure, the processor 710 may select an AP in the first group to be included in the second group based on a dilution of precision (DoP) indicating the degree to which APs to be calculated are unevenly distributed.

According to an embodiment of the disclosure, the processor 710 may determine the AP used to determine the DoP as the second group based on the identifying that the DoP is less than a specified value.

According to an embodiment of the disclosure, the processor 710 may determine the location of the electronic device by using an AP in the second group.

According to an embodiment of the disclosure, the processor 710 may transmit a signal requesting map information to an external device based on the fact that there is no map information in the memory 130.

According to an embodiment of the disclosure, the processor 710 may determine at least one AP located within a certain distance from the second location of the electronic device as a first group based on the information on the second location of the electronic device 500 being stored in the memory, determine, based on a signal received from the AP in the first group, a first distance between an AP in the first group and the electronic device, determine, based on the map information, a second distance between the AP in the first group and the electronic device, and determine an AP in which the difference between the first distance and the second distance is less than a certain level among at least one AP in the first group as a second group.

According to an embodiment of the disclosure, a method of measuring a location of the electronic device 500 may include determining, based on map information including location information of a plurality of access points (APs) in a specific area, at least one AP located within a certain distance from a first location of the electronic device among the plurality of APs as a first group in operation 820, determining based on a signal received from the AP in the first group, a first distance between an AP in the first group and the electronic device, determining based on the map information, a second distance between the AP in the first group and the electronic device, determining an AP in which the difference between the first distance and the second distance is less than a certain level among at least one AP in the first group as a second group, and determining a second location of the electronic device by using an AP in the second group in operation 830.

According to an embodiment of the disclosure, the first location may be determined by using all APs detected in the specific area.

According to an embodiment of the disclosure, the method of measuring a location of the electronic device 500 may further include selecting an AP in the first group to be included in the second group based on at least one of a received signal strength indicator (RSSI) indicating the strength of a received signal, an estimated distance between the electronic device and the AP in the first group, or the number of non-response of the AP in the first group to a request from the electronic device.

According to an embodiment of the disclosure, the method of measuring a location of the electronic device 500 may further include determining, based on the information about the second location of the electronic device being stored in the memory 130, at least one AP located within a certain distance from the second location of the electronic device as a third group in operation 920, determining, based on a signal received from the AP in the third group, a third distance between the AP in the third group and the electronic device, determining, based on the map information, a fourth distance between the AP in the third group and the electronic device, and determining an AP in which the difference between the third distance and the fourth distance is less than a certain level among at least one AP in the first group as a fourth group in operation 930.

According to an embodiment of the disclosure, the method of measuring a location of the electronic device 500 may further include selecting an AP in the first group to be included in the second group based on a dilution of precision (DoP) indicating the degree to which APs to be calculated are unevenly distributed.

According to an embodiment of the disclosure, the method of measuring a location of the electronic device 500 may further include determining the AP used to determine the DoP as the second group based on the identifying that the DoP is less than a specified value.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit configured to communicate with an external electronic device;
memory, storing one or more computer programs, including map information including location information of a plurality of access points (APs) in a specific area; and
one or more processors communicatively coupled to the communication circuit and the memory,
wherein the one or more computer programs include computer-executable instructions that, when executed by the one or more processors individually or collectively, cause the electronic device to:
determine, based on the map information, at least one AP located within a certain distance from a first location of the electronic device among the plurality of APs as a first group,
determine, based on a signal received from the AP in the first group, a first distance between an AP in the first group and the electronic device,
determine, based on the map information, a second distance between the AP in the first group and the electronic device,
determine an AP in which a difference between the first distance and the second distance is less than a certain level among at least one AP in the first group as a second group, and
determine a second location of the electronic device by using an AP in the second group, and
wherein the first location is determined based on a signal broadcast by the plurality of APs in the specific area.

2. The electronic device of claim 1, wherein the one or more computer programs further include computer-executable instructions that, when executed by the one or more processors individually or collectively, cause the electronic device to determine the first location by using all APs detected in the specific area.

3. The electronic device of claim 1, wherein the one or more computer programs further include computer-executable instructions that, when executed by the one or more processors individually or collectively, cause the electronic device to select an AP in the first group to be included in the second group based on at least one of a received signal strength indicator (RSSI) indicating a strength of a received signal, an estimated distance between the electronic device and the AP in the first group, or a number of non-response of the AP in the first group to a request from the electronic device.

4. The electronic device of claim 3, wherein the one or more computer programs further include computer-executable instructions that, when executed by the one or more processors individually or collectively, cause the electronic device to:
determine a score of an AP in the first group based on whether the RSSI is below a certain level, whether a change in the estimated distance between the electronic device and the AP in the first group exceeds a certain level, and/or whether the number of non-response times of the AP in the first group to a request from the electronic device exceeds a certain level, and
select an AP in the first group to be included in the second group based on the determined score.

5. The electronic device of claim 1, wherein the one or more computer programs further include computer-executable instructions that, when executed by the one or more processors individually or collectively, cause the electronic device to:
determine, based on the map information, at least one AP located within a certain distance from the second location of the electronic device among the plurality of APs as a third group,
determine, based on a signal received from the AP in the third group, a third distance between the AP in the third group and the electronic device,
determine, based on the map information, a fourth distance between the AP in the third group and the electronic device,
determine an AP in which a difference between the third distance and the fourth distance is less than a certain level among at least one AP in the third group as a fourth group, and
determine a third location of the electronic device by using an AP in the fourth group.

6. The electronic device of claim 1, wherein the one or more computer programs further include computer-executable instructions that, when executed by the one or more processors individually or collectively, cause the electronic device to select an AP in the first group to be included in the second group based on a dilution of precision (DoP) indicating a degree to which APs to be calculated are unevenly distributed.

7. The electronic device of claim 6, wherein the one or more computer programs further include computer-executable instructions that, when executed by the one or more processors individually or collectively, cause the electronic device to determine the AP used to determine the DoP as the second group based on identifying that the DoP is less than a specified value.

8. The electronic device of claim 1, wherein the one or more computer programs further include computer-executable instructions that, when executed by the one or more processors individually or collectively, cause the electronic device to:
determine at least one AP located within a certain distance from the second location of the electronic device as a first group based on information on the second location of the electronic device being stored in the memory,
determine, based on a signal received from the AP in the first group, a first distance between an AP in the first group and the electronic device,
determine, based on the map information, a second distance between the AP in the first group and the electronic device, and
determine an AP in which the difference between the first distance and the second distance is less than a certain level among at least one AP in the first group as a second group.

9. The electronic device of claim 8, wherein the one or more computer programs further include computer-executable instructions that, when executed by the one or more processors individually or collectively, cause the electronic device to determine a location of the electronic device by using an AP in the second group.

10. The electronic device of claim 1, wherein the one or more computer programs further include computer-executable instructions that, when executed by the one or more processors individually or collectively, cause the electronic device to transmit a signal requesting map information to an external device based on a fact that there is no map information in the memory.

11. A method of measuring a location of an electronic device, the method comprising:
determining, by the electronic device, based on map information including location information of a plurality of access points (APs) in a specific area, at least one AP located within a certain distance from a first location of the electronic device among the plurality of APs as a first group;
determining, by the electronic device, based on a signal received from the AP in the first group, a first distance between an AP in the first group and the electronic device;
determining, by the electronic device, based on the map information, a second distance between the AP in the first group and the electronic device;
determining, by the electronic device, an AP in which a difference between the first distance and the second distance is less than a certain level among at least one AP in the first group as a second group; and
determining, by the electronic device, a second location of the electronic device by using an AP in the second group,
wherein the first location is determined based on a signal broadcast by the plurality of APs in the specific area.

12. The method of claim 11, wherein the first location is determined by using all APs detected in the specific area.

13. The method of claim 11, further comprising:
selecting an AP in the first group to be included in the second group based on at least one of a received signal strength indicator (RSSI) indicating a strength of a received signal, an estimated distance between the electronic device and the AP in the first group, or a number of non-response of the AP in the first group to a request from the electronic device.

14. The method of claim 13, further comprising:
determining a score of an AP in the first group based on whether the RSSI is below a certain level, whether a change in the estimated distance between the electronic device and the AP in the first group exceeds a certain level, and/or whether the number of non-response times of the AP in the first group to a request from the electronic device exceeds a certain level; and
selecting an AP in the first group to be included in the second group based on the determined score.

15. The method of claim 11, further comprising:
determining, based on the map information, at least one AP located within a certain distance from the second location of the electronic device among the plurality of APs as a third group;
determining, based on a signal received from the AP in the third group, a third distance between the AP in the third group and the electronic device;
determining, based on the map information, a fourth distance between the AP in the third group and the electronic device;
determining an AP in which a difference between the third distance and the fourth distance is less than a certain level among at least one AP in the third group as a fourth group; and
determining a third location of the electronic device by using an AP in the fourth group.

16. The method of claim 11, further comprising:
selecting an AP in the first group to be included in the second group based on a dilution of precision (DoP) indicating a degree to which APs to be calculated are unevenly distributed.

17. The method of claim 16, further comprising:
determining the AP used to determine the DoP as the second group based on identifying that the DoP is less than a specified value.

18. The method of claim 11, further comprising:
determining at least one AP located within a certain distance from the second location of the electronic device as a first group based on the information on the second location of the electronic device being stored in memory;
determining, based on a signal received from the AP in the first group, a first distance between an AP in the first group and the electronic device;
determining, based on the map information, a second distance between the AP in the first group and the electronic device; and
determining an AP in which the difference between the first distance and the second distance is less than a certain level among at least one AP in the first group as a second group.

19. One or more non-transitory computer-readable storage media storing one or more computer programs including computer-executable instructions that, when executed by one or more processors of an electronic device individually or collectively, cause the electronic device to perform operations of measuring a location of an electronic device, the operations comprising:
determining, by the electronic device, based on map information including location information of a plurality of access points (APs) in a specific area, at least one AP located within a certain distance from a first location of the electronic device among the plurality of APs as a first group;
determining, by the electronic device, based on a signal received from the AP in the first group, a first distance between an AP in the first group and the electronic device;
determining, by the electronic device, based on the map information, a second distance between the AP in the first group and the electronic device;
determining, by the electronic device, an AP in which a difference between the first distance and the second distance is less than a certain level among at least one AP in the first group as a second group; and
determining, by the electronic device, a second location of the electronic device by using an AP in the second group,
wherein the first location is determined based on a signal broadcast by the plurality of APs in the specific area.

20. The one or more non-transitory computer-readable storage media of claim 19, wherein the first location is determined by using all APs detected in the specific area.
